(19) United States
(12) Patent Application Publication
(10) Pub. No.: US 2024/0053095 A1
(43) Pub. Date: Feb. 15, 2024

(54) COMBINED CYCLE NATURAL GAS PROCESSING SYSTEM

(71) Applicant: JGC Corporation, Yokohama-shi, Kanagawa (JP)

(72) Inventors: Yuzuru KAKUTANI, Yokohama-shi, Kanagawa (JP); Ryosuke SUGIE, Yokohama-shi, Kanagawa (JP)

(21) Appl. No.: 18/268,268

(22) PCT Filed: Dec. 21, 2021
(86) PCT No.: PCT/JP2021/047228

§ 371 Date: Jun. 19, 2023

(30) Foreign Application Priority Data
Dec. 21, 2020 (WO) PCT/JP2020/047748

(51) Int. Cl. F25J 1/00; F25J 1/02

(52) U.S. Cl. CPC F25J 1/0022; F25J 1/023; F25J 1/0244; F25J 2220/62; F25J 2230/30

(57) ABSTRACT

Combined cycle natural gas processing system that does not discharge carbon dioxide to the atmosphere. The system is provided with an acid gas removal unit that separates carbon dioxide contained in natural gas, and includes a natural gas processing plant that produces liquefied natural gas, and a carbon dioxide cycle. High energy held by a high-temperature and high-pressure carbon dioxide fluid of the carbon dioxide cycle is converted into electrical energy or mechanical energy and supplied to a power consumption device and an energy consumption device provided in the natural gas processing plant. The carbon dioxide fluid extracted from the carbon dioxide cycle and a carbon dioxide separation stream separated by the acid gas removal unit are supplied to a carbon dioxide reception facility capable of receiving carbon dioxide, so that the carbon dioxide generated with production of the liquefied natural gas is not released to the atmosphere.

### TECHNICAL FIELD

The present invention relates to a natural gas processing plant that produces liquefied natural gas and does not discharge a carbon dioxide gas.

### BACKGROUND ART

A natural gas processing plant (hereinafter, also referred to as “LNG plant”) producing liquefied natural gas (LNG) cools natural gas (NG) using a refrigerant to produce liquefied and subcooled LNG, as disclosed in Patent Literature 1, for example.

This LNG plant is provided with a large number of energy consumption devices including a compressor that compresses a refrigerant vaporized by heat exchange with NG, and a power machine such as a pump that transports LNG.

For example, some compressors are configured to drive a gas turbine using NG as fuel or a steam turbine driven by steam obtained by combusting fuel to compress a refrigerant. In these cases, fuel is combusted in the LNG plant to discharge carbon dioxide (CO₂).

Alternatively, even in a case where a compressor or another power machine is driven using a motor, electric power for driving the power machine may also be supplied from a stand-alone electric power generation facility provided in the LNG plant. The stand-alone electric power generation facility generally adopts a method of driving a generator using a fuel gas or steam, and CO₂ is discharged from the LNG plant even in such a case.

In addition, NG contains CO₂ as acid gases in some cases, and some LNG plants include an acid gas removal unit (AGRU) that removes these acid gases from NG.

Conventionally, an acid gas separated from NG has been released to the atmosphere after combustion and removal of environmental pollutants. In this case, CO₂ separated from NG is also discharged to the atmosphere together with other CO₂ generated by the combustion.

As described above, the LNG plant has a plurality of CO₂ emission sources. Meanwhile, there is a demand for LNG plants with CO₂ emissions reduced as much as possible from the viewpoint of reducing greenhouse gas emissions.

Here, the above-described Patent Literature 1 describes that light ends flushed from LNG by a device (end flash vessel) provided in an NG liquefaction apparatus is used as a fuel gas in a factory (paragraph 0023). On the other hand, Patent Literature 1 has no description regarding the handling of CO₂ generated by combusting this fuel gas, and thus, it is considered that such CO₂ is also discharged to the atmosphere.

Meanwhile, Patent Literature 2 describes a power generation system in which a hydrocarbon gas and oxygen are combusted under supply of boiler water in a gas generator, and a steam turbine is rotated by a combusted gas containing CO₂ and steam to obtain mechanical energy and electrical energy (paragraphs 0032 to 0033 and FIG. 1). In addition, Patent Literature 3 describes a power plant in which a turbine is driven by an effluent gas obtained by combusting natural gas (NG) in a combustor under supply of oxygen to perform energy conversion by power generation, driving of a compressor, or the like, and the effluent gas is cooled to separate water, and the water is supplied again to the compressor on an inlet side of the combustor (Column 7, line 28 to Column 8, line 3, and FIGS. 4 and 5).

Here, each plant described in Patent Literatures 2 and 3 is installed for the purpose of obtaining energy for power generation and compressor driving, and thus, it is necessary to control stable properties and a fuel flow rate in accordance with required energy. In this regard, the power generation system described in Patent Literature 2 is configured such that LNG is supplied from a storage tank or a vessel to the above-described gas generator (paragraph 0029, FIG. 1, and the like). In addition, the same also applies to the power plant described in Patent Literature 3, and this plant is configured to be supplied with gas having stable properties and supply flow rate such as natural gas (NG), LNG, or synthesis gas (Column 2, lines 2 to 4, and FIGS. 4 and 5). As described above, the plants described in Patent Literatures 2 and 3 are “external fuel receiving type” plants in which dedicated fuel is procured in accordance with the purpose of energy supply, such as power generation, without depending on operating conditions of other facilities.

It is clearly described in Patent Literatures 2 and 3 that it is common technical knowledge that such an external fuel receiving type energy supply plant is operated using fuel having stable properties and supply amount, such as LNG which is a product produced by the NG liquefaction apparatus of Patent Literature 1. Therefore, the NG liquefaction apparatus of Patent Literature 1 merely has a role of supplying LNG as the product in relation to the various plants described in Patent Literatures 2 and 3. Thus, when the NG liquefaction apparatus described in Patent Literature 1 and the plants described in Patent Literatures 2 and 3 are combined, it is the fact that the entire CO₂ contained in an exhaust gas after the combustion is released to the atmosphere regarding light hydrocarbon components by-produced in the NG liquefaction apparatus and are used as the fuel gas in the plants.

### CITATION LIST

### Patent Literature

Patent Literature 1: WO 2017/154181 A Patent Literature 2: US 2006/0032228 A Patent Literature 3: U.S. Pat. No. 5,724,805

### SUMMARY OF INVENTION

### Technical Problem

The present technology provides a combined cycle natural gas processing system that combusts a light hydrocarbon gas, by-produced in a natural gas processing plant, with high-purity oxygen and does not discharge generated carbon dioxide to the atmosphere.

### Solution to Problem

A first combined cycle natural gas processing system includes: a natural gas processing plant that produces liquefied natural gas from natural gas; and a carbon dioxide cycle power plant that includes a power generation turbine using a carbon dioxide fluid as a driving fluid, and performs power generation using a carbon dioxide cycle that pressurizes and heats the carbon dioxide fluid discharged from the power generation turbine and supplies the carbon dioxide fluid again to the power generation turbine. The natural gas processing plant includes an acid gas removal unit (AGRU) that separates carbon dioxide contained in the natural gas. The carbon dioxide cycle power plant includes: a combustor that is provided on an inlet side of the power generation turbine, mixes the pressurized and heated carbon dioxide fluid with a light hydrocarbon gas containing methane as a main component and a high-purity oxygen gas and combusts the carbon dioxide fluid mixed with the light hydrocarbon gas and the high-purity oxygen gas to generate the carbon dioxide fluid containing high-temperature and high-pressure steam, the light hydrocarbon gas being by-produced when the liquefied natural gas is produced in the natural gas processing plant; a separator that cools the carbon dioxide fluid containing the steam, discharged from the power generation turbine and decompressed, to condense and separate the steam; and an extraction facility that extracts a carbon dioxide fluid exceeding a required circulation amount, determined according to electric power that needs to be obtained by the power generation, out of the carbon dioxide fluid from which moisture has been separated by the separator. Electric power obtained by driving a generator using the power generation turbine is supplied to a power consumption device provided in the natural gas processing plant, the carbon dioxide fluid extracted from the extraction facility and a carbon dioxide separation stream separated by the acid gas removal unit are supplied to a carbon dioxide reception facility capable of receiving carbon dioxide, and the carbon dioxide generated with production of the liquefied natural gas is not released to atmosphere.

In addition, a second combined cycle natural gas processing system includes: a natural gas processing plant that produces liquefied natural gas from natural gas; and a carbon dioxide cycle power plant that includes a power generation turbine using a carbon dioxide fluid as a driving fluid, and performs power generation using a carbon dioxide cycle that pressurizes and heats the carbon dioxide fluid discharged from the power generation turbine and supplies the carbon dioxide fluid again to the power generation turbine. The natural gas processing plant includes: an acid gas removal unit (AGRU) that separates carbon dioxide contained in the natural gas; a pressurizing unit that pressurizes a carbon dioxide separation stream separated by the acid gas removal unit; and a carbon dioxide supply line that causes the carbon dioxide separation stream pressurized in the pressurizing unit to join the carbon dioxide fluid flowing in the carbon dioxide cycle. The carbon dioxide cycle power plant includes: a combustor that is provided on an inlet side of the power generation turbine, mixes the pressurized and heated carbon dioxide fluid with a light hydrocarbon gas containing methane as a main component and a high-purity oxygen gas and combusts the carbon dioxide fluid mixed with the light hydrocarbon gas and the high-purity oxygen gas to generate the carbon dioxide fluid containing high-temperature and high-pressure steam, the light hydrocarbon gas being by-produced when the liquefied natural gas is produced in the natural gas processing plant; a separator that cools the carbon dioxide fluid containing the steam, discharged from the power generation turbine and decompressed, to condense and separate the steam; and an extraction facility that extracts a carbon dioxide fluid exceeding a required circulation amount, determined according to electric power that needs to be obtained by the power generation, out of the carbon dioxide fluid from which moisture has been separated by the separator. Electric power obtained by driving a generator using the power generation turbine is supplied to a power consumption device provided in the natural gas processing plant, the carbon dioxide fluid extracted from the extraction facility is supplied to a carbon dioxide reception facility capable of receiving carbon dioxide, and the carbon dioxide generated with production of the liquefied natural gas is not released to atmosphere.

Further, a third combined cycle natural gas processing system includes: a natural gas processing plant that produces liquefied natural gas from natural gas; and a carbon dioxide cycle plant that includes an energy conversion turbine configured to convert energy held by a driving fluid into mechanical energy using a carbon dioxide fluid as the driving fluid, and obtains the mechanical energy using a carbon dioxide cycle that pressurizes and heats the carbon dioxide fluid discharged from the energy conversion turbine and supplies the carbon dioxide fluid again to the energy conversion turbine. The natural gas processing plant includes an acid gas removal unit (AGRU) that separates carbon dioxide contained in the natural gas. The carbon dioxide cycle plant includes: a combustor that is provided on an inlet side of the energy conversion turbine, mixes the pressurized and heated carbon dioxide fluid with a light hydrocarbon gas containing methane as a main component and a high-purity oxygen gas and combusts the carbon dioxide fluid mixed with the light hydrocarbon gas and the high-purity oxygen gas to generate the carbon dioxide fluid containing high-temperature and high-pressure steam, the light hydrocarbon gas being by-produced when the liquefied natural gas is produced in the natural gas processing plant; a separator that cools the carbon dioxide fluid containing the steam, discharged from the energy conversion turbine and decompressed, to condense and separate the steam; and an extraction facility that extracts a carbon dioxide fluid exceeding a required circulation amount, determined according to the mechanical energy that needs to be obtained by the energy conversion, out of the carbon dioxide fluid from which moisture has been separated by the separator. The mechanical energy obtained by driving the energy conversion turbine is supplied to a mechanical energy consumption device provided in the natural gas processing plant, the carbon dioxide fluid extracted from the extraction facility and a carbon dioxide separation stream separated by the acid gas removal unit are supplied to a carbon dioxide reception facility capable of receiving carbon dioxide, and the carbon dioxide generated with production of the liquefied natural gas is not released to atmosphere.

Then, a fourth combined cycle natural gas processing system includes: a natural gas processing plant that produces liquefied natural gas from natural gas; and a carbon dioxide cycle plant that includes an energy conversion turbine configured to convert energy held by a driving fluid into mechanical energy using a carbon dioxide fluid as the driving fluid, and recovers energy using a carbon dioxide cycle that pressurizes and heats the carbon dioxide fluid discharged from the energy conversion turbine and supplies the carbon dioxide fluid again to the energy conversion turbine. The natural gas processing plant includes: an acid gas removal unit (AGRU) that separates carbon dioxide contained in the natural gas; a pressurizing unit that pressurizes a carbon dioxide separation stream separated by the acid gas removal unit; and a carbon dioxide supply line that causes the carbon dioxide separation stream pressurized in the pressurizing unit to join the carbon dioxide fluid flowing in the carbon dioxide cycle. The carbon dioxide cycle plant includes: a combustor that is provided on an inlet side of the energy conversion turbine, mixes the pressurized and heated carbon dioxide fluid with a light hydrocarbon gas containing methane as a main component and a high-purity oxygen gas and combusts the carbon dioxide fluid mixed with the light hydrocarbon gas and the high-purity oxygen gas to generate the carbon dioxide fluid containing high-temperature and high-pressure steam, the light hydrocarbon gas being by-produced when the liquefied natural gas is produced in the natural gas processing plant; a separator that cools the carbon dioxide fluid containing the steam, discharged from the energy conversion turbine and decompressed, to condense and separate the steam; and an extraction facility that extracts a carbon dioxide fluid exceeding a required circulation amount, determined according to the mechanical energy that needs to be obtained by the energy conversion, out of the carbon dioxide fluid from which moisture has been separated by the separator. The mechanical energy obtained by driving the energy conversion turbine is supplied to a mechanical energy consumption device provided in the natural gas processing plant, the carbon dioxide fluid extracted from the extraction facility is supplied to a carbon dioxide reception facility capable of receiving carbon dioxide, and the carbon dioxide generated with production of the liquefied natural gas is not released to atmosphere.

In the third and fourth combined cycle natural gas processing systems, the mechanical energy consumption device may be a rotary device provided in the natural gas processing plant, and the energy conversion turbine may be a drive turbine configured to drive the rotary device. The carbon dioxide cycle plant may further include a power generation turbine that converts the energy held by the driving fluid into electrical energy, and electric power obtained by driving a generator using the power generation turbine may be supplied to a power consumption device provided in the natural gas processing plant.

The first to fourth combined cycle natural gas processing systems may have the following features.
(a) The carbon dioxide fluid extracted from the extraction facility is supplied to the carbon dioxide reception facility that is at least one selected from a facility group including a carbon dioxide capture and storage (CCS) facility, an enhanced oil recovery facility (EOR) facility, a urea synthesis facility, a carbon dioxide mineralization facility, a methanation facility, and a carbon dioxide supply facility for photosynthesis promotion.
(b) The carbon dioxide separation stream separated by the acid gas removal unit is supplied to a carbon dioxide capture and storage (CCS) facility which is the carbon dioxide reception facility and is configured to pressurize and store the carbon dioxide separation stream, and the carbon dioxide fluid extracted from the extraction facility is supplied to the CCS facility which is the carbon dioxide reception facility, and joins the pressurized carbon dioxide separation stream, and the joined carbon dioxide fluid and the carbon dioxide separation stream are stored together.
(c) The natural gas processing plant includes an air separation unit (ASU) configured to separate air into an oxygen gas and a nitrogen gas to produce the oxygen gas to be supplied to the combustor, and the air separation unit includes a nitrogen gas supply line configured to supply the obtained nitrogen gas to at least one nitrogen gas use facility selected from a utility facility, a facility that supplies a purge gas to a seal drum of a flare stack, a facility that supplies a blanket gas to a storage tank, and a facility that supplies a microbubble gas for promoting a separation function in an oil-water separation unit. At this time, the natural gas processing plant includes a nitrogen gas separation unit that separates a nitrogen gas from the light hydrocarbon gas that is supplied to the combustor and contains the methane as the main component, and the nitrogen gas separated by the nitrogen gas separation unit joins nitrogen in the nitrogen gas supply line and is used in the nitrogen gas use facility.
(d) An acid gas combustion facility that combusts an acid gas, which is separated from the carbon dioxide separation stream and contains a sulfur compound, is provided, and the carbon dioxide cycle is provided with a carbon dioxide fluid heating unit that heats the carbon dioxide fluid using combustion exhaust heat of the acid gas in the acid gas combustion facility.
(e) The natural gas processing plant includes a light hydrocarbon gas supply line configured to supply a boil-off gas, vaporized in a storage tank storing the liquefied natural gas (LNG), as the light hydrocarbon gas to the combustor.

In (f) and (e), the natural gas processing plant includes: a main cryogenic heat exchanger that liquefies and subcools the natural gas to obtain the LNG; an end flash unit that decompresses the LNG sent from the main cryogenic heat exchanger to a pressure of the storage tank and separates an end flash gas generated by the decompressing from the liquefied natural gas; an auxiliary supply line that causes a light hydrocarbon gas obtained by vaporizing the LNG in the end flash unit to join the light hydrocarbon gas supply line; and a control unit that executes control to increase a temperature of the LNG at an outlet of the main cryogenic heat exchanger in order to increase an evaporation amount of the LNG in the end flash unit in a case where a supply flow rate of the light hydrocarbon gas supplied from the light hydrocarbon gas supply line to the combustor is less than a target supply flow rate necessary for maintaining the required circulation amount of the carbon dioxide fluid even when an entire amount of the boil-off gas that is suppliable from the storage tank is supplied to the light hydrocarbon gas supply line.

In (g) and (e), the natural gas processing LNG plant includes: a main cryogenic heat exchanger that liquefies and subcools the natural gas to obtain the LNG; an auxiliary supply line that extracts a part of the natural gas before being liquefied, which is supplied to the main cryogenic heat exchanger, from an inlet side of the main cryogenic heat exchanger to join the light hydrocarbon gas supply line as the light hydrocarbon gas; and a control unit that executes control to increase an extraction amount of the natural gas from the inlet side of the main cryogenic heat exchanger in a case where a supply flow rate of the light hydrocarbon gas supplied from the light hydrocarbon gas supply line to the combustor is less than a target supply flow rate necessary for maintaining the required circulation amount of the carbon dioxide fluid even if an entire amount of the boil-off gas that is suppliable from the storage tank is supplied to the light hydrocarbon gas supply line.
(h) The power consumption device includes a drive motor of a compressor that executes compression of a refrigerant to compress, cool, and liquefy the refrigerant again after the refrigerant used in the natural gas processing plant for cooling the natural gas is vaporized by heat exchange with the natural gas.
(i) The carbon dioxide cycle includes a heat exchange unit that heats a heating medium by heat exchange between the carbon dioxide fluid at a high temperature flowing in the carbon dioxide cycle and the heating medium flowing between the carbon dioxide cycle and the natural gas processing plant, and the heating medium heated by the heat exchange unit raises a temperature of a fluid to be heated, which flows through a device requiring a heat source provided in the natural gas processing plant, in a heating unit, and then, is supplied again to the heat exchange unit in a state of being lowered in temperature. At this time, the acid gas removal unit includes: an absorption column which absorbs an acid gas containing the carbon dioxide contained in the natural gas using a gas absorbing liquid; a regeneration column which regenerates the gas absorbing liquid; and a reboiler which raises a temperature of the gas absorbing liquid in the regeneration column and desorb the absorbed acid gas, and the heating unit is a reboiler, and the fluid to be heated is the gas absorbing liquid in the regeneration column.

### Advantageous Effects of Invention

According to the present combined cycle natural gas processing system, the carbon dioxide cycle is also installed in the natural gas processing plant for producing the liquefied natural gas, and the light hydrocarbon gas mainly containing methane, which is by-produced in the natural gas processing plant, is combusted with high-purity oxygen to supply combustion energy to the carbon dioxide cycle. Then, in the carbon dioxide cycle, the energy of the carbon dioxide fluid is converted into electrical energy or mechanical energy. As a result, it is possible to effectively utilize the thermal energy generated by the combustion of the light hydrocarbon gas by-produced in the natural gas processing plant, and the carbon dioxide in the carbon dioxide cycle is supplied to various carbon dioxide reception facilities in the high purity and high pressure state, and thus, the release to the atmospheric associated with the combustion of the light hydrocarbon gas is not performed.

In addition, the carbon dioxide separated from the natural gas in the acid gas removal unit of the natural gas processing plant is also supplied to the carbon dioxide reception facilities together with the above-described carbon dioxide fluid directly or after being once merged with the carbon dioxide fluid circulating in the carbon dioxide cycle, and thus, is not discharged to the outside.

### BRIEF DESCRIPTION OF DRAWINGS

FIG. 1 is a configuration diagram illustrating an example of a combined cycle natural gas processing system according to an embodiment.

FIG. 2 is a configuration diagram illustrating another example of the combined cycle natural gas processing system.

FIG. 3 is a configuration diagram illustrating an example of a supply control mechanism of a light hydrocarbon gas for a CO₂ cycle power plant.

FIG. 4 is a configuration diagram illustrating another example of the supply control mechanism of the light hydrocarbon gas.

FIG. 5 is a configuration example of a combined cycle natural gas processing system that performs both mechanical energy supply and electrical energy supply from a CO₂ cycle to a device provided in an LNG plant.

FIG. 6 is a configuration example of a combined cycle natural gas processing system that performs thermal energy supply from a CO₂ cycle to a device provided in an LNG plant.

FIG. 7 is a configuration example of a combined cycle natural gas processing system that performs thermal energy supply from a device provided in an LNG plant to a CO₂ cycle.

### DESCRIPTION OF EMBODIMENTS

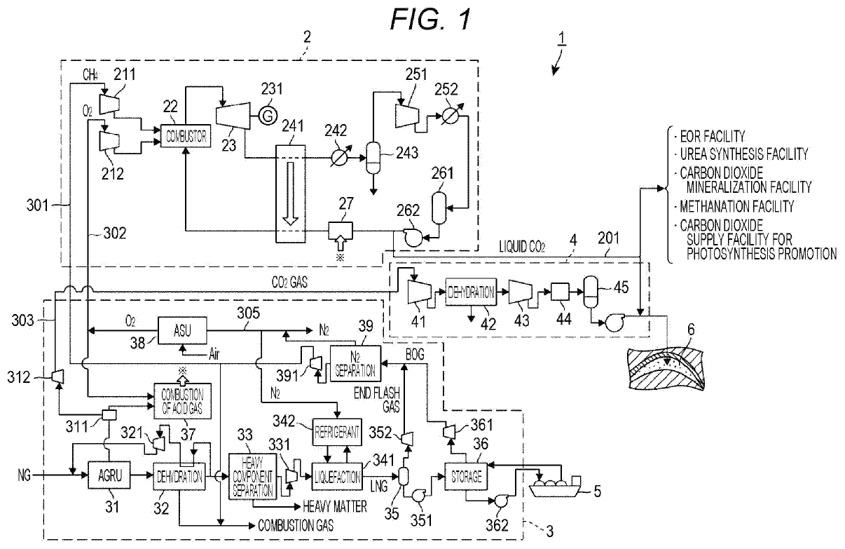

FIG. 1 is a configuration diagram of a combined cycle natural gas processing system 1 according to a first embodiment. The combined cycle natural gas processing system 1 of the present example includes: an LNG plant (natural gas processing plant) 3 that produces liquefied natural gas (LNG) from natural gas (NG); a supercritical (SC)-CO₂ cycle power plant (carbon dioxide cycle power plant) 2 that performs cycle power generation using carbon dioxide (CO₂) in a supercritical state.

In the example illustrated in FIG. 1, the combined cycle natural gas processing system 1 includes facilities for a pretreatment system that removes an impurity and a heavy component contained in NG, and a facility that liquefies and subcools the pretreated NG.

As the facilities for the pretreatment system, an acid gas removal unit (AGRU) 31 that separates acid gases such as CO₂ and hydrogen sulfide (H₂S) contained in NG, a dehydration unit 32 that removes moisture contained in NG, and a heavy component separation unit 33 that removes heavy hydrocarbons heavier than methane contained in NG are provided FIG. 1. In addition, the LNG plant 3 may include a gas-liquid separation unit that removes a liquid component contained in NG received from a wellhead, a mercury removal unit that removes mercury in NG, and the like as the facilities for the pretreatment system.

The AGRU 31 removes the acid gases, such as CO₂ and H₂S, which are likely to solidify in LNG during liquefaction. As a method for removing the acid gases, it is possible to apply a method using a gas absorbing liquid containing an amine compound or a method using a gas separation membrane that allows permeation of the acid gases in NG.

The acid gases separated from NG by the AGRU 31 are separated into CO₂ containing a trace of light hydrocarbons and the other acid gases containing a sulfur compound such as H₂S by an extraction operation or the like using a gas absorbing liquid of an amine compound in a separation unit 311. The acid gases from which CO₂ containing a trace of light hydrocarbons has been separated is combusted in an acid gas combustion facility 37 to be detoxified, subjected to a treatment for removing air pollutants as necessary, and then, released to the atmosphere. When a sulfur concentration in the acid gases is high, sulfur is recovered and then combusted in the combustion facility 37.

In addition, a CO₂ gas separated from the other acid gases in the separation unit 311 is sent to a CCS facility 4, which will be described later, as a CO₂ separation stream (carbon dioxide separation stream).

The dehydration unit 32 removes a trace of moisture contained in the NG. For example, the dehydration unit 32 is filled with an adsorbent such as a molecular sieve or a silica gel, and includes: a plurality of adsorption columns in which an NG moisture removal operation and a regeneration operation of the adsorbent having adsorbed moisture are alternately switched; and a device such as a heater that heats a regeneration gas (for example, NG after moisture removal) of the adsorbent supplied to the adsorption columns where the regeneration operation is being performed.

NG containing moisture after being used for regeneration of the adsorbent is pressurized using a regeneration gas compressor 321 and returned to an inlet side of the AGRU 31, or is used as a fuel gas for a heater and the like provided in the combined cycle natural gas processing system 1.

The NG from which impurities such as the acid gases and moisture have been removed is subjected to a treatment of removing a heavy component heavier than methane in the heavy component separation unit 33. The heavy component separation unit 33 includes a cooler that cools the NG to liquefy the heavy component, a distillation column (demethanizer) that performs distillation and separation between a light gas (methane gas) containing methane as a main component and the liquefied heavy component, and the like. In addition, the heavy component separated from the methane gas by the demethanizer is distilled and separated into ethane, propane, butane, and a heavy condensate using a plurality of rectification columns.

The cooler that liquefies the heavy component may use the methane gas sent from the demethanizer as a self-refrigerant or may use a pre-cooling medium such as propane (FIG. 1 illustrates the former case). In a case where NG is cooled using the pre-cooling medium, a pre-cooling medium cycle is provided in which the pre-cooling medium is vaporized by heat exchange with the NG, then, a gas thereof is compressed, cooled, and liquefied again, and supplied to the cooler.

The methane gas from which the heavy component has been separated is pressurized by the separation unit 311 including a compressor as necessary, and then, cooled by a liquefying unit 341 to be liquefied, thereby producing LNG. The liquefying unit 341 includes, for example, a main cryogenic heat exchanger (MCHE) that cools, liquefies, and subcools NG with a liquefaction refrigerant that is a mixed refrigerant containing a plurality of types of refrigerant raw materials such as nitrogen, methane, ethane, and propane.

In addition, the liquefying unit 341 is provided together with a liquefaction refrigerant cycle 342 for compressing, cooling, and re-liquefying a gas of the liquefaction refrigerant vaporized by heat exchange with the methane gas, and supplying the resultant to the MCHE.

The LNG produced in the liquefying unit 341 is decompressed to a pressure equal to or lower than a reception pressure on an LNG tank (storage tank) 36 side in an end flash unit 35, and then, sent to the LNG tank 36 by an LNG pump 351. From the LNG tank 36, LNG is shipped to the LNG carrier 5 using a shipping pump 362, and the LNG loaded on the LNG carrier 5 is transported to a demand site.

The LNG plant 3 having the schematic configuration described above includes dynamic devices such as a compressor that compresses the above-described various refrigerants, a compressor (for example, a compressor of the regeneration gas compressor 321 or an NG pressurizing unit 331, a compressor 361 of a BOG to be described later, or a compressor 352 of an end flash gas) that pressurizes NG or the like, and pumps (for example, the LNG pump 351 and the shipping pump 362) for transfer of LNG. These dynamic devices consume energy to pressurize and transport various fluids, and the combined cycle natural gas processing system 1 of the present example is configured to operate these dynamic devices (power consumption devices) using a drive motor driven by electric power generated in the SC-CO₂ cycle power plant 2.

The SC-CO₂ cycle power plant 2 is a known power plant that generates power by driving a power generation turbine 23 using CO₂ in the supercritical state as a driving fluid. In the example illustrated in FIG. 1, the SC-CO₂ cycle power plant 2 includes a CO₂ cycle for pressurizing and heating CO₂ that has been used for driving of the power generation turbine 23 and supplying the CO₂ again to the power generation turbine 23.

Hereinafter, a configuration example of the CO₂ cycle will be described with reference to FIG. 1.

The power generation turbine 23 of the CO₂ cycle is provided with a combustor 22, which combusts a light hydrocarbon gas to supply CO₂, on an inlet side. The combustor 22 replenishes CO₂ to the CO₂ cycle by mixing and combusting an oxygen (O₂) gas and light hydrocarbon gas in a flow of SC-CO₂. In addition, steam is also generated by the combustion of the light hydrocarbon gas in the combustor 22.

In the combined cycle natural gas processing system 1 of the present example, a light hydrocarbon gas mainly containing a methane gas generated (by-produced) in the process of producing and storing LNG in the LNG plant 3 is used as the light hydrocarbon gas to be combusted in the combustor 22. In the following description, the light hydrocarbon (HC) gas containing methane as the main component is also simply referred to as an “HC gas”.

More specifically, the boil-off gas (BOG) generated by vaporization of a part of LNG in the LNG tank 36, the end flash gas generated when the pressure of LNG is adjusted in the end flash unit 35, and the like are used. These HC gases are separated from a nitrogen (N₂) gas by a nitrogen gas separation unit 39, then pressurized by an HC gas supply unit 391 including a compressor, and supplied to the SC-CO₂ cycle power plant 2 through an HC gas supply line 301. Note that reference signs 352 and 361 denote the compressors that supply the end flash gas and the BOG to the nitrogen gas separation unit 39, respectively. As described above, both the BOG and the end flash gas are supplied to the SC-CO₂ cycle power plant 2 as the HC gas that is the methane gas with high purity from which the N₂ gas has been removed.

An HC gas pressurizing unit 211 that pressurizes the HC gas is provided on the inlet side of the combustor 22, and the HC gas supplied through the HC gas supply line 301 is pressurized to a supply pressure for the CO₂ cycle, and then, introduced into the combustor 22.

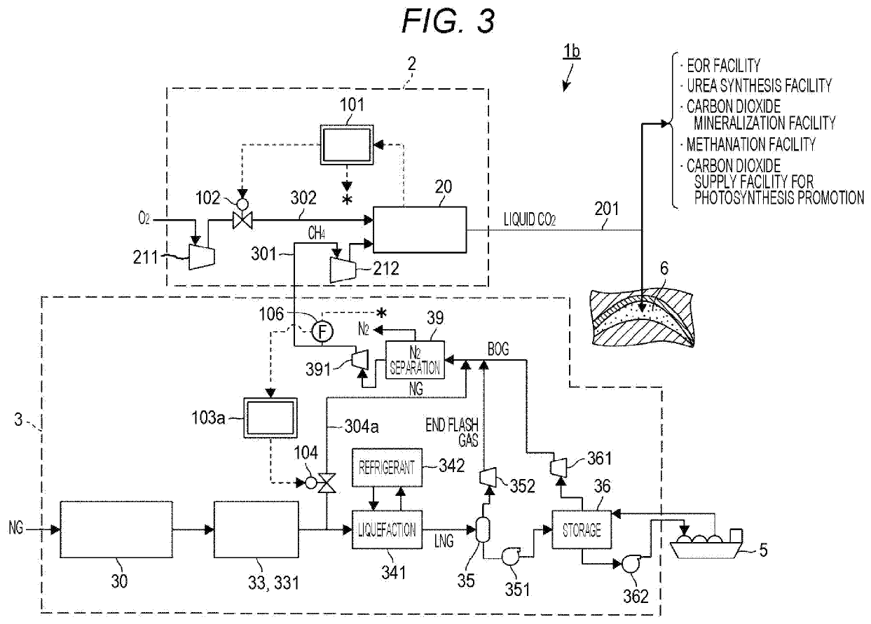

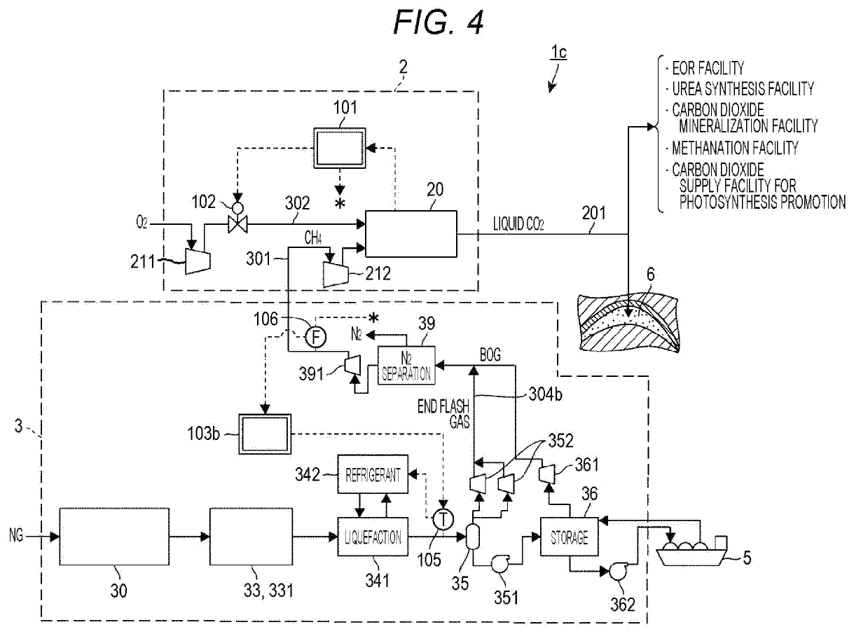

Note that a configuration example of a supply control mechanism configured to supply a required amount of the HC gas for the CO₂ cycle will be described in detail with reference to FIGS. 3 and 4.

In addition, the HC gas is combusted in the combustor 22 using, for example, a high-purity O₂ gas having a concentration equal to or higher than 99.8%. Thus, the LNG plant 3 is provided with an air separation unit (ASU) 38 configured to separate air into an O₂ gas and a N₂ gas to produce the oxygen gas to be supplied to the combustor 22.

The O₂ gas produced in the ASU 38 is supplied to the SC-CO₂ cycle power plant 2 through an O₂ gas supply line 302. An oxygen gas pressurizing unit 212 that pressurizes the O₂ gas is provided on the inlet side of the combustor 22, and the O₂ gas supplied through the O₂ gas supply line 302 is pressurized to the supply pressure for the CO₂ cycle, and then, introduced into the combustor 22.

Note that a part of the O₂ gas produced by the ASU 38 is supplied to the above-described acid gas combustion facility 37 and used for the combustion of the acid gas.

In the ASU 38 described above, the N₂ gas is produced together with the O₂ gas. This N₂ gas is supplied to at least one N₂ gas use facility selected from a utility facility that supplies the N₂ gas as necessary in the combined cycle natural gas processing system 1, a facility that supplies a purge gas into a seal drum of a flare stack for combusting a surplus gas, a facility that supplies a blanket gas to a gas phase side in the LNG tank 36 to prevent formation of a flammable air-fuel mixture, and a facility that is used an oil-water separation unit, which performs oil-water separation of oil-containing wastewater discharged from a device in the combined cycle natural gas processing system 1, and supplies a microbubble gas into the wastewater to promote the oil-water separation function. The N₂ gas is supplied to these N₂ gas use facilities through a N₂ gas supply line 305. In addition, the N₂ gas may be used as a part of the refrigerant for liquefying and subcooling the methane gas.

In addition, the BOG and the end flash gas supplied to the combustor 22 as the HC gases are subjected to the N₂ gas separation in the nitrogen gas separation unit 39 as described above. The N₂ gas separated from the HC gases by the nitrogen gas separation unit 39 also merges with the nitrogen of the above-described N₂ gas supply line 305 and is used in each of the N₂ gas use facilities or is used as a part of the refrigerant for liquefying and subcooling the methane gas.

Returning to the description of the configuration of the CO₂ cycle, the SC-CO₂ replenished with CO₂ in the combustor 22 is supplied to the power generation turbine 23, and power generation is performed by driving the power generation turbine 23 to which a generator 231 is connected. Electric power obtained by the power generation is supplied to each power consumption device in the LNG plant 3 and the SC-CO₂ cycle power plant 2 including the compressor that compresses the refrigerant to be used for the production of LNG.

The CO₂ gas discharged from the power generation turbine 23 and decompressed is subjected to heat exchange with CO₂ before being supplied to the combustor 22 in a heat exchanger 241, and then, further cooled in a cooler 242. Through these cooling operations, the steam generated by combustion of the HC gas is condensed, and moisture is separated in a gas-liquid separator 243.

The CO₂ gas from which the moisture has been separated is compressed by a compressor 251 and further cooled by a cooler 252 to become liquid CO₂ and flow into a drum 261.

The liquid CO₂ in the drum 261 is pressurized by a pressurizing pump 262, further heated to be in a state of SC-CO₂, and supplied again to combustor 22. In the CO₂ cycle of the present example, as means for heating CO₂, a CO₂ fluid heating unit 27 that uses exhaust heat obtained by combusting the acid gas in the above-described acid gas combustion facility 37 provided on the SC-CO₂ cycle power plant 2 side, the heat exchanger 241 that performs heat exchange with the CO₂ gas discharged from the power generation turbine 23, and the above-described combustor 22 that uses the combustion heat of the HC gas are provided.

Although simplified in FIG. 1, the heating of the CO₂ gas using the CO₂ fluid heating unit 27 will be briefly described. For example, the acid gas combustion facility 37 includes a heat exchange unit (not illustrated) capable of heating a heating medium such as hot oil, hot water, or steam by the combustion heat of the HC gas. The high-temperature heating medium heated in the acid gas combustion facility 37 is sent to the CO₂ fluid heating unit 27. The CO₂ fluid heating unit 27 heats the CO₂ gas using the high-temperature heating medium. The heating medium of which the temperature has decreased due to the heat exchange with the CO₂ gas in the CO₂ fluid heating unit 27 is supplied again to the heat exchange unit of the acid gas combustion facility 37.

In FIG. 1, the CO₂ fluid heating unit 27 is installed on the upstream side of the heat exchanger 241, but the CO₂ fluid heating unit 27 may be incorporated in the heat exchanger 241. Since a position of the CO₂ fluid heating unit 27 is determined by a heat level obtained in the acid gas combustion facility 37, the position is not limited.

Returning to the description of the CO₂ cycle, the power generation is performed in the SC-CO₂ cycle power plant 2 by circulating a CO₂ fluid (CO₂ gas, liquid CO₂, or SC-CO₂) in the CO₂ cycle to drive the power generation turbine 23. Thus, the combustion gas containing CO₂ is not released to the atmosphere as compared with a power plant using a gas turbine generator that drives a turbine by combusting a fuel gas or a steam turbine generator that drives a turbine by steam generated by combusting fuel. In addition, a high-purity and high-pressure CO₂ fluid can be obtained from the CO₂ cycle.

In this regard, the SC-CO₂ cycle power plant 2 of the present example is configured to be capable of extracting a part of the CO₂ fluid circulating in the CO₂ cycle toward a CO₂ reception facility configured for storage, fixation, utilization, and the like of CO₂. In the present example, a liquid CO₂ extraction line 201 for extracting the liquid CO₂ before being heated by the CO₂ fluid heating unit 27 from a position on an outlet side of the pressurizing pump 262 provided in the CO₂ cycle is provided. The liquid CO₂ extraction line 201 corresponds to a CO₂ fluid extraction facility in the present example.

The pressure of the liquid CO₂ extracted through the liquid CO₂ extraction line 201 can be exemplified by a value within a range of 8 to 30 MPa. In addition, a flow rate of the liquid CO₂ extracted through the liquid CO₂ extraction line 201 is adjusted so as to maintain a state in which a circulation amount (required circulation amount) of the CO₂ fluid, required for the generator 231 to generate power, circulates through the CO₂ cycle with a preset output. That is, the CO₂ fluid exceeding the required circulation amount is extracted through the liquid CO₂ extraction line 201.

The liquid CO₂ extracted by the liquid CO₂ extraction line 201 is supplied to at least one carbon dioxide reception facility (CO₂ reception facility) selected from a facility group including a carbon dioxide capture and storage (CCS) facility that stores CO₂ in an underground aquifer 6, an enhanced oil recovery facility (EOR) facility that increases oil production by injecting CO₂ into an oil field by pressure, a urea synthesis facility that causes CO₂ to react with ammonia (NH 3) to synthesize urea, a carbon dioxide mineralization facility that causes CO₂ to react with calcium or magnesium to be fixed, a methanation facility in which methane (CH 4) is produced using CO₂ as a raw material, and a carbon dioxide supply facility for photosynthesis promotion configured to increase a crop production amount.

Here, the CCS facility may be configured to store CO₂ in a deep salt water layer of the sea floor. In addition, in a case where CO₂ is supplied to the EOR and the CCS in parallel, components of the EOR facility and the CCS facility may be shared.

Note that the extraction of CO₂ in a liquid state is not an essential requirement, and the CO₂ gas may be supplied according to the CO₂ reception specification on the CO₂ reception facility side. For example, a CO₂ gas extraction line as an extraction facility may be connected to a position on an outlet side of the gas-liquid separator 243 provided in the CO₂ cycle. Since the pressure of CO₂ in the CO₂ cycle is higher than the atmospheric pressure, high-purity and high-pressure CO₂ can be supplied even when the CO₂ gas before being compressed by the compressor 251 is extracted.

Further, in the combined cycle natural gas processing system 1, the CO₂ gas separated from the NG in the AGRU 31 of the LNG plant 3 may also be supplied to at least one CO₂ reception facility selected from the above-described facility group together with the liquid CO₂ extracted from the CO₂ cycle.

For example, an example in which the CO₂ gas sent from the separation unit 311 at the subsequent stage of the AGRU 31 is pressurized by the CO₂ gas pressurizing unit 312 and sent to the CCS facility 4 through the CO₂ gas extraction line 303 is illustrated in the combined cycle natural gas processing system 1 illustrated in FIG. 1. The CO₂ gas flowing through the CO₂ gas extraction line 303 corresponds to a carbon dioxide separation stream of the present embodiment.

In the CCS facility 4, the received CO₂ gas is compressed by a CO₂ compressor 41 (in this case, the compressor 41 may be shared with the CO₂ gas pressurizing unit 312 or omitted), and condensed moisture is separated by the CO₂ dehydration unit 42. Subsequently, the CO₂ gas is compressed again by a CO₂ compressor 43 and then cooled by a cooler 44, thereby obtaining high purity and high pressure liquid CO₂. The CO₂ liquefied in the CCS facility 4 is separated into gas and liquid by a gas-liquid separator 45, and is sent to the underground aquifer 6 by a CO₂ pump 46.

On the other hand, the liquid CO₂ extracted from the SC-CO₂ cycle power plant 2 through the liquid CO₂ extraction line 201 described above is separated from moisture, and has a sufficiently high pressure. Thus, this liquid CO₂ joins the liquid CO₂ discharged from the SC-CO₂ cycle power plant 2 side on the outlet side of the CO₂ pump 46 in the CCS facility 4 and can be directly stored in the underground aquifer 6 as in the example illustrated in FIG. 1. As a result, the amount of CO₂ processing in the CCS facility 4 can be reduced, and facility cost of the CCS facility 4 can be reduced.

Even when being supplied to another CO₂ reception facility other than the CCS facility 4, the CO₂ gas discharged from the LNG plant 3 (AGRU 31) is subjected to pressurization, moisture removal, and liquefaction according to the reception specification of each CO₂ reception facility. Then, this CO₂ gas is supplied to each CO₂ reception facility together with the CO₂ fluid (CO₂ gas or liquid CO₂) extracted from the SC-CO₂ cycle power plant 2.

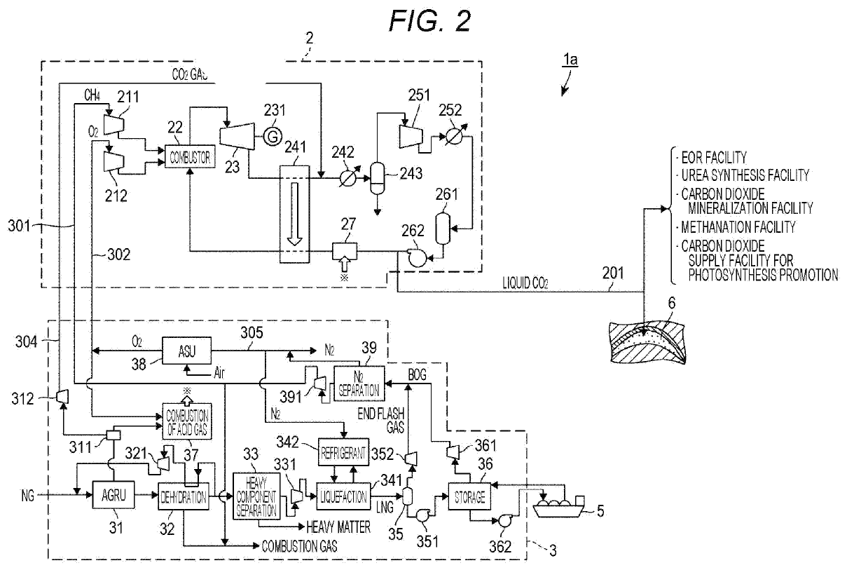

Next, a configuration example of a combined cycle natural gas processing system 1a according to a second embodiment will be described with reference to FIG. 2. Note that the same constituent elements as those of the combined cycle natural gas processing system 1 described with reference to FIG. 1 are denoted by the same reference signs as those illustrated in FIG. 1 in FIGS. 2 to 6 to be described hereinafter.

The combined cycle natural gas processing system 1a of FIG. 2 has a configuration in which a CO₂ gas, separated from NG by the AGRU 31, is pressurized by the CO₂ gas pressurizing unit 312 via a CO₂ gas supply line 304, and then, is supplied to the CO₂ cycle of the SC-CO₂ cycle power plant 2. In this regard, the configuration is different from that of the combined cycle natural gas processing system 1 illustrated in FIG. 1 in which the CO₂ gas separated by the AGRU 31 is supplied to the CCS facility 4 without passing through the CO₂ cycle. The CO₂ gas flowing through the CO₂ gas supply line 304 corresponds to a carbon dioxide separation stream of the present embodiment.

In the example illustrated in FIG. 2, the CO₂ gas pressurized by the CO₂ gas pressurizing unit 312 joins a CO₂ fluid (CO₂ gas at this position) circulating in the CO₂ cycle at the position between an outlet side of the power generation turbine 23 and the cooler 242, for example, between the heat exchanger 241 and the cooler 242.

The joined CO₂ gas is subjected to moisture separation, pressurization, liquefaction, and heating together with the other CO₂ fluid, and forms SC-CO₂ to drive the generator 231.

Here, as compared with a case where CO₂ is supplied using only the combustor 22 capable of supplying high-temperature CO₂ by combustion of an HC gas, the supply of a relatively low-temperature CO₂ gas from another position as described above also becomes a factor of lowering the thermal efficiency of the CO₂ cycle. On the other hand, it is not necessary to provide the CCS facility 4 described with reference to FIG. 1, the facility investment at the time of construction can be suppressed.

The combined cycle natural gas processing systems 1 and 1a according to the respective embodiments described above have the following effects. The LNG plant 3 that produces LNG is provided together with the SC-CO₂ cycle power plant 2 that performs power generation using the CO₂ cycle. This LNG plant 3 combusts the HC gas (light hydrocarbon gas containing methane as the main component), by-produced in the LNG plant 3, with the high-purity O₂ gas (of which the concentration is equal to or higher than 99.8%) obtained by the air separation using the ASU 38, and supplies the obtained CO₂ having high energy to the CO₂ cycle. Then, the power generation is performed in the CO₂ cycle. As a result, the high energy at high pressure and high temperature obtained by combusting the HC gas by-produced in the LNG plant 3 can be effectively utilized. In addition, the low-energy CO₂ consumed in the CO₂ cycle is still supplied to various CO₂ reception facilities in the high-purity state, and thus, the release of CO₂ to the atmosphere accompanying the combustion of the HC gas is not performed.

In addition, CO₂ separated from NG in the AGRU 31 of the LNG plant 3 is not released to the atmosphere either by being supplied to the CO₂ reception facilities directly with the above-described CO₂ fluid or after once joining the CO₂ fluid circulating in the CO₂ cycle.

Next, a configuration example of a control system that supplies the HC gas to the CO₂ cycle 20 will be described with reference to FIGS. 3 and 4.

In FIGS. 3 and 4, the description of each device in the CO₂ cycle 20 of the SC-CO₂ cycle power plant 2 is omitted, and a comprehensive description is given. In addition, a comprehensive description is also given regarding the AGRU 31, the pretreatment unit 30 including the dehydration unit 32 and its ancillary devices, the heavy component separation unit 33, and the NG pressurizing unit 331 of the LNG plant 3. In addition, the description of the ASU 38 is omitted.

A generation amount of a BOG supplied to the SC-CO₂ cycle power plant 2 as an HC gas greatly increases or decreases depending on the outside temperature, the presence or absence of shipment to the LNG carrier 5, and the like. In addition, the end flash unit 35 is the device provided for pressure adjustment of LNG as described above, and is not normally configured to prioritize securing of a supply amount of the HC gas with respect to the CO₂ cycle 20.

In this regard, a combined cycle natural gas processing system 1b illustrated in FIG. 3 is configured to remove impurities and heavy components and replenish NG before being liquefied as the HC gas when the supply amount is insufficient only with the BOG and an end flash gas with respect to the demand for the HC gas in the CO₂ cycle 20.

In the example illustrated in FIG. 3, a flow rate of each gas supplied toward the CO₂ cycle 20 is controlled using a combustor supply gas control unit 101. At this time, a supply amount of an O₂ gas is adjusted by a supply control valve 102 provided in the O₂ gas supply line 302.

On the other hand, a flowmeter 106 is provided in the HC gas supply line 301 that supplies the HC gas toward the CO₂ cycle 20, and an extraction amount of NG is controlled such that a flow rate of the HC gas detected by the flowmeter 106 approaches a target value. In the present example, the target value of the flow rate of the HC gas is set by the combustor supply gas control unit 101. In addition, the extraction amount of NG is controlled by adjusting an opening degree of an extraction control valve 104, provided in an auxiliary supply line 304a, by an HC gas supply control unit 103a. The auxiliary supply line 304a is connected to an inlet side of the MCHE in order to extract a part of NG before being liquefied that is supplied to the MCHE provided in the liquefying unit 341.

With this configuration, when the generation amount of the BOG and the extraction amount of the end flash gas are small and the flow rate of the flowmeter 106 is insufficient with respect to the target value, control is performed to increase the opening degree of the extraction control valve 104 to increase the extraction amount of NG. On the other hand, when the generation amount of the BOG and the extraction amount of the end flash gas are sufficient and the flow rate of the flowmeter 106 exceeds the target value, control is performed to reduce the opening degree of the extraction control valve 104 to decrease the extraction amount of NG.

Next, as another embodiment of the supply control mechanism of the HC gas, a combined cycle natural gas processing system 1c illustrated in FIG. 4 is configured to increase or decrease an extraction amount of an end flash gas. Specifically, control of the extraction amount of NG is executed by an HC gas supply control unit 103b. In this case, a piping line from which the end flash gas is extracted corresponds to an auxiliary supply line 304b.

Note that a plurality of the CO₂ gas pressurizing units 312 may be arranged in parallel on an outlet side of the end flash unit 35 as illustrated in FIG. 4 in order to secure sufficient air supply capacity of the end flash gas in this configuration.

A control operation of the configuration illustrated in FIG. 4 will be described. When a generation amount of a BOG is small and a flow rate of the flowmeter 106 is insufficient with respect to a target value, an LNG temperature control unit 105, which is provided on an outlet side of the liquefying unit 341 and includes a temperature detection unit that detects the temperature of LNG, performs control to increase the temperature of LNG at the outlet of the liquefying unit 341. As a result, a generation amount of the end flash gas (evaporation amount of LNG) in the end flash unit 35 increases.

On the other hand, when the generation amount of the BOG is sufficient and the flow rate of the flowmeter 106 exceeds the target value, the temperature of LNG at the outlet of the liquefying unit 341 is lowered to decrease the generation amount of the end flash gas.

Here, a type of energy, which is supplied to an energy consumption device provided in the LNG plant 3 using the CO₂ cycle, is not limited to the electrical energy generated by the generator 231. The high energy (high-temperature and high-pressure combustion energy) of CO₂ flowing in the CO₂ cycle may be converted into mechanical energy and supplied.

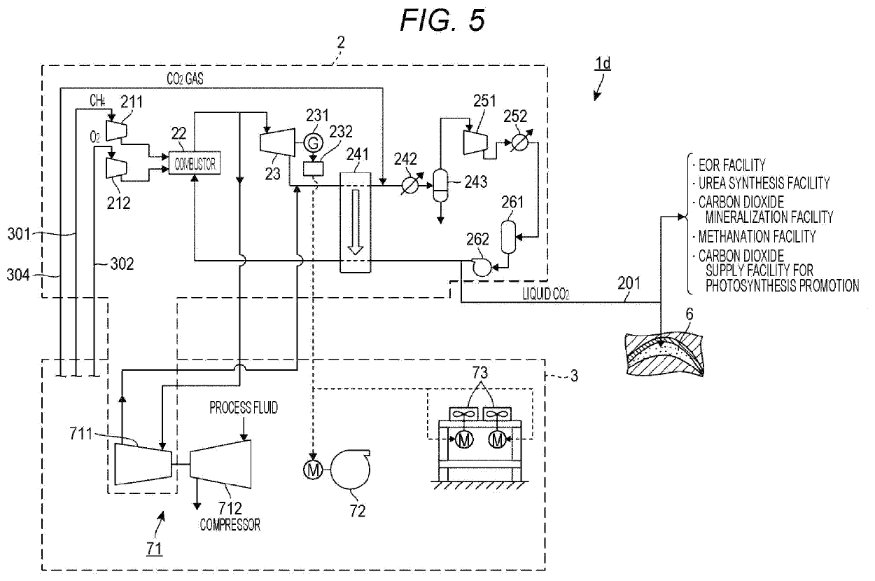

FIG. 5 schematically illustrates an example of an energy consumption device that receives supply of electrical energy or mechanical energy from the SC-CO₂ cycle power plant (carbon dioxide cycle plant) 2 in a frame illustrating the LNG plant 3 of a combined cycle natural gas processing system 1d.

The SC-CO₂ cycle power plant 2 illustrated in FIG. 5 supplies electric power to a motor that drives a pump 72 for liquid transportation flowing in the LNG plant 3, and a drive motor of an air cooled heat exchanger (ACHE) 73 that cools fluid. In FIG. 5, a reference sign 232 indicates an electrical room including a device for performing voltage control and power transmission control of the electric power generated by the generator 231. The ACHE 73 may be provided at the top of a pipe rack, or may be provided near the ground while holding the ACHE 73 by a dedicated frame. The motor of the pump 72 and the ACHE 73 correspond to power consumption devices of the present example. In addition to these, an electric heater can be exemplified as the power consumption device to which the electric power is supplied from the SC-CO₂ cycle power plant 2.

Further, the SC-CO₂ cycle power plant 2 illustrated in FIG. 5 is configured to extract SC-CO₂ in the supercritical state from the outlet side of the combustor 22 and supply the extracted SC-CO₂ to the power machines such as the compressor and the pump in addition to the power supply to the power consumption devices. FIG. 5 illustrates an example in which SC-CO₂ is supplied to a turbine 711 of a turbine type compressor 71 provided in the LNG plant 3. The turbine 711 drives a compressor 712 that compresses a process fluid flowing in the LNG plant 3. The decompressed CO₂ gas after having been used to drive the compressor 712 is returned to an inlet side of the heat exchanger 241 provided in the CO₂ cycle. Examples of the process fluid can include various kinds of refrigerants (a pre-cooling medium for pre-cooling NG, or a liquefaction refrigerant for liquefying or subcooling NG) vaporized by heat exchange, NG (feed gas) supplied to the regeneration gas compressor 321 and the compressor of the NG pressurizing unit 331, and BOG generated in the LNG tank 36.

In addition, SC-CO₂ extracted from the SC-CO₂ cycle power plant 2 may be supplied to a turbine that drives a pump pressurizing a liquid. As the process fluid in this case, boiler water or the like can be exemplified.

The compressor 712 and the pump described above correspond to rotary devices of the present example, and the compressor 711 for driving these rotary devices corresponds to an energy conversion turbine of the SC-CO₂ cycle power plant (carbon dioxide cycle plant) 2.

As described above, the SC-CO₂ cycle power plant 2 illustrated in FIG. 5 is configured to be capable of supplying SC-CO₂ to the power generation turbine 23 and the energy conversion turbine (for example, the turbine 711 in FIG. 5) in parallel and performing both conversion into electrical energy and conversion into mechanical energy. In this example, a required circulation amount for circulating the CO₂ cycle is adjusted so as to maintain a circulation amount that enables the generator 231 to perform the power generation at a preset output and the compressor 711 to perform the conversion into the mechanical energy at a preset output.

A single (external fuel receiving type) power plant that combusts fuel having stable properties to obtain CO₂ circulating in the CO₂ cycle is normally intended to convert energy of high-temperature and high-pressure SC-CO₂ into electrical energy. Thus, the power generation turbine 23 have a large size is provided, and the entire amount of high-temperature and high-pressure SC-CO₂ obtained in the combustor 22 is supplied to the power generation turbine 23 to generate power. On the other hand, when a part of the high-temperature and high-pressure fluid of SC-CO₂ is directly extracted and used for driving the turbine 711 as in the SC-CO₂ cycle power plant 2 of the present example, the amount of electric power generated by the power generation turbine 23 decreases by such a usage.

In this regard, the combined cycle natural gas processing system 1d of the present example is provided with the LNG plant 3 and the SC-CO₂ cycle power plant 2 together, which is different from the single power plant intended for power generation. With this configuration, it is possible to more freely provide a supply form contributing to improvement of energy efficiency of the entire combined cycle natural gas processing system 1d to each device in the LNG plant 3 without being limited to only the supply of electrical energy.

In general, when the energy of high-temperature and high-pressure SC-CO₂ is used, it is most efficient to use the energy in a state of thermal energy by heat exchange or the like (energy efficiency is about 98%). Then, the energy efficiency decreases in the order of the conversion into mechanical energy for driving the turbine (about 40%) and the conversion into electrical energy (about 30%).

In this regard, since the SC-CO₂ cycle power plant 2 is provided together with the LNG plant 3 in the combined cycle natural gas processing system 1d of the present example, it is possible to select the energy supply form from SC-CO₂ of the high-temperature and high-pressure fluid while considering the function and scale of each energy consumption device and to enhance the energy efficiency of the entire combined cycle natural gas processing system 1d. Thus, the energy efficiency of the entire combined cycle natural gas processing system 1d can be improved as compared with a case where the entire energy is supplied as electrical energy. As described above, it is difficult to derive the idea of selecting the supply/use form of energy in each device to improve the energy efficiency of the entire combined cycle natural gas processing system 1d from the external fuel receiving type power plant installed only for power generation.

In addition, in a case where the LNG plant 3 is not provided with the SC-CO₂ cycle power plant 2, it is necessary to combust an HC fuel gas in a boiler for generating steam or a gas turbine if the compressor 712 is driven by a steam turbine or the gas turbine. At this time, if CO₂ generated by combustion of the fuel gas is not recovered, the CO₂ is released to the atmosphere.

In this regard, the SC-CO₂ cycle power plant 2 illustrated in FIG. 5 is configured to drive the turbine 711 by extracting SC-CO₂ from the CO₂ cycle as described above. With this configuration, it is unnecessary to use the boiler and the gas turbine, and it is also unnecessary to use a facility for recovering CO₂ generated in these facilities. As a result, it is possible to configure the combined cycle natural gas processing system 1d that does not release CO₂ to the atmosphere with a relatively simple configuration.

As described above, it is difficult to drive the configuration of the combined cycle natural gas processing system 1d that avoids not only the comprehensive energy efficiency but also the release of CO₂ to the atmosphere from the external fuel receiving type CO₂ cycle power plant that does not include an energy utilization device other than the power generation facility.

Further, installing the turbine type compressor 71 that supplies high-temperature and high-pressure SC-CO₂ to the turbine 711 to drive the compressor 712 also has an effect of reducing a footprint (occupied area) of a facility. For example, in the case of a gas turbine compressor that drives the compressor 712 using a gas turbine, it is necessary to provide an air compressor that compresses combustion air.

In general, the air compressor provided together with the gas turbine compressor is extremely large and has a large footprint. On the other hand, it is unnecessary to provide the air compressor together with the turbine type compressor 71 of the present example using high-temperature and high-pressure SC-CO₂, and there is a possibility that the footprint can be reduced to about ⅓ as compared with the gas turbine compressor. As a result, it is possible to obtain a significant cost reduction effect in terms of both device cost and site cost.

Note that it is not essential to provide the power generation turbine 23 and the generator 231 together with the CO₂ cycle plant that supplies SC-CO₂ to the turbine 711 for driving the compressor 712. A carbon dioxide cycle plant including only an energy conversion turbine that supplies mechanical energy to a rotary device may be configured.

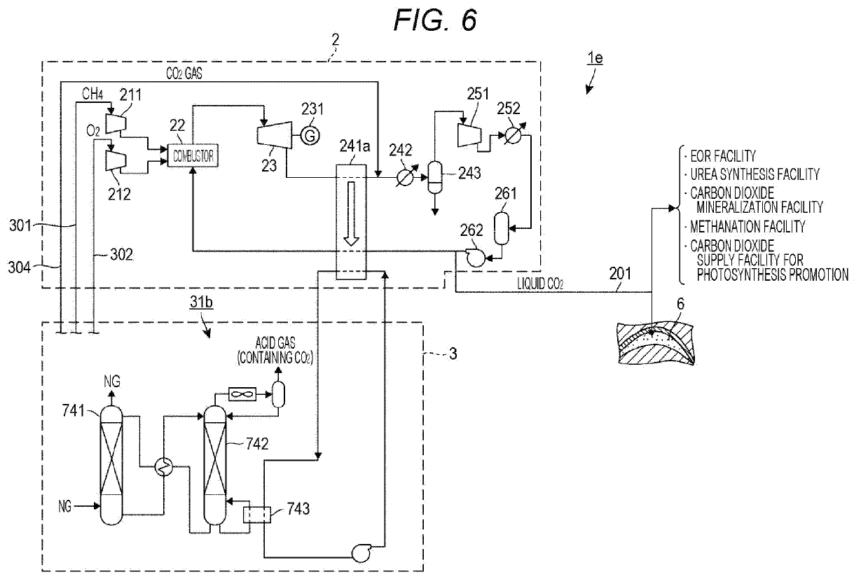

In addition, thermal energy may be supplied from the CO₂ cycle to a “device requiring a heat source” provided in the LNG plant 3 through a heat exchange unit, in addition to the conversion into mechanical energy and electrical energy. A combined cycle natural gas processing system 1e of FIG. 6 is an example in which a heat exchanger (heat exchange unit) 241a that heats a heating medium (hot oil, hot water, or steam) is provided in the SC-CO₂ cycle power plant 2 in addition to heating of CO₂ before being supplied to the combustor 22 by heat exchange with CO₂ discharged from the power generation turbine 23.

The heating medium heated by the heat exchanger 241a is used for heating of a fluid to be heated by a reboiler 743 which is a heat exchange unit provided in the LNG plant 3, and then, is supplied again to the heat exchanger 241a.

FIG. 6 illustrates an AGRU 31b configured to absorb and remove an acid gas containing CO₂ from NG using a gas absorbing liquid in an absorption column 741. The AGRU 31b includes a regeneration column 742 configured to heat the gas absorbing liquid to desorb the acid gas and regenerate the gas absorbing liquid. In the present example, the reboiler 743 of the regeneration column 742, which is the device requiring the heat source, is configured as the above-described heat exchange unit, and the high-temperature heating medium is supplied from the above-described heat exchanger 241a to the reboiler 743. The low-temperature heating medium after having been used to raise the temperature of the gas absorbing liquid in the reboiler 743 is supplied again to the heat exchanger 241a in a cooled state.

In the above example, the gas absorbing liquid in the regeneration column 742 corresponds to the fluid to be heated, and the reboiler 743 corresponds to a heating unit for the fluid to be heated.

In addition, in the case of adopting a configuration for separating CO₂ from another acid gas using a gas absorbing liquid as in the separation unit 311 described with reference to FIGS. 1 and 2, the reboiler 743 may be provided in a regeneration column provided in the separation unit 311. In this example as well, thermal energy of the high-temperature heating medium supplied from the heat exchanger 241a on the SC-CO₂ cycle power plant 2 side is used for regeneration of the gas absorbing liquid.

Here, the fluid to be heated to which thermal energy is supplied from the CO₂ cycle is not limited to the gas absorbing liquid for which regeneration is performed. For example, a heavy component which is subjected to distillation and separation in the distillation column and the rectification column of the heavy component separation unit 33 or a regeneration gas used for regeneration of the adsorbent in the dehydration unit 32 may be used as the fluid to be heated. As the heating medium for heating the fluid to be heated, the above-described hot oil, hot water, steam, or the like can be appropriately selected. In this case, various distillation column and rectification column provided in the LNG plant 3 correspond to the “device requiring the heat source” in the present example, and the reboiler and the heater provided in the distillation column and the rectification column correspond to the “heating unit” in the present example.

As described above, the combined cycle natural gas processing system 1e illustrated in FIG. 6 is configured to supply the thermal energy from the SC-CO₂ cycle power plant 2 to the LNG plant 3. However, a direction of transfer of the thermal energy is not limited to this example.

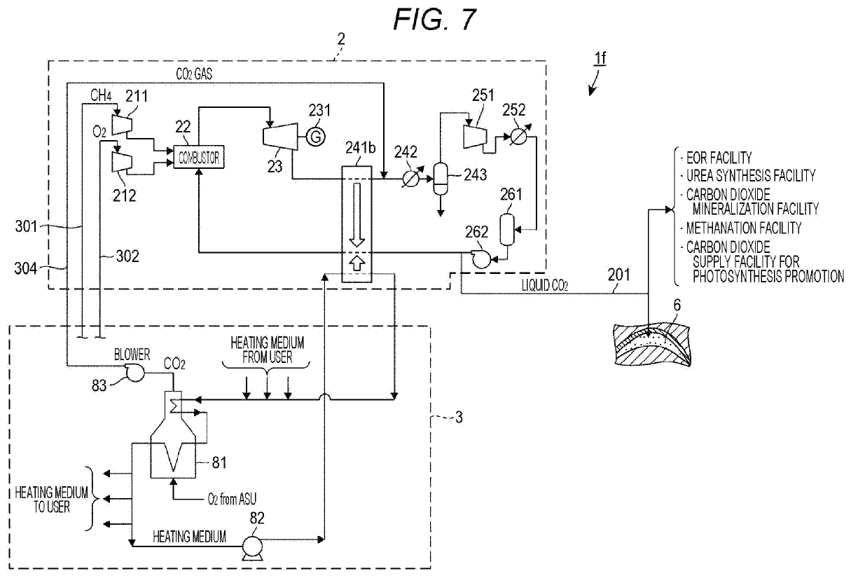

For example, a combined cycle natural gas processing system if illustrated in FIG. 7 is configured to supply thermal energy from a device provided in the LNG plant 3 to the SC-CO₂ cycle power plant 2.

In the combined cycle natural gas processing system if illustrated in FIG. 7, the LNG plant 3 includes an oxygen combustion heater 81 that combusts fuel using a high-purity O₂ gas supplied from the ASU 38 to heat a heating medium (hot oil, hot water, or steam). A CO₂ gas generated by combusting the fuel in the oxygen combustion heater 81 is pressurized by a blower 83 and supplied to the CO₂ cycle of the SC-CO₂ cycle power plant 2 through the CO₂ gas supply line 304.

On the other hand, a part of the high-temperature heating medium heated by the oxygen combustion heater 81 is supplied to each user in the LNG plant 3. In addition, a part of the high-temperature heating medium is also supplied to the heat exchanger 241b provided in the CO₂ cycle of the SC-CO₂ cycle power plant 2 by a pump 82. The heat exchanger 241b of the present example heats CO₂ before being supplied to the combustor 22 by heat exchange with the heating medium heated by the oxygen combustion heater 81 in addition to heat exchange with CO₂ discharged from the power generation turbine 23 in the CO₂ cycle.

The low-temperature heating medium after having been used to heat CO₂ in the heat exchanger 241b is returned to the oxygen combustion heater 81 and heated. In addition, the low-temperature heating medium returned from each user in the LNG plant 3 joins a flow path for returning the heating medium from the heat exchanger 241b to the oxygen combustion heater 81, is returned to the oxygen combustion heater 81, and is heated.

As described above, when the high thermal energy obtained in a fuel combustion facility such as the oxygen combustion heater 81 is excessive on the LNG plant 3 side, the excessive thermal energy can be supplied to the SC-CO₂ cycle power plant 2 side through the heat exchanger 241b. As a result, a combustion amount of an HC gas combusted in the combustor 22 can be reduced as compared with a case where the thermal energy is not supplied.

In addition, the CO₂ fluid heating unit 27 illustrated in FIGS. 1 and 2 also corresponds to an example of the configuration in which the thermal energy excessive on the LNG plant 3 side is supplied to the SC-CO₂ cycle power plant 2 side.

The combined cycle natural gas processing system 1e described with reference to FIG. 6 is configured to supply the thermal energy from the SC-CO₂ cycle power plant 2 side to the LNG plant 3 side. In addition to this example, it is also possible to adopt the configuration in which the thermal energy is also supplied from the LNG plant 3 side to the SC-CO₂ cycle power plant 2 side as in the combined cycle natural gas processing system if illustrated in FIG. 7. For example, the heat exchanger 241 may have both functions of a function of supplying heat to the LNG plant 3 and a function of receiving heat from the LNG plant 3 according to the balance of the thermal energy.

As described above, in the configuration in which the LNG plant 3 and the SC-CO₂ cycle power plant 2 are provided together, the thermal energy can be supplied from one side of the LNG plant 3 and the SC-CO₂ cycle power plant 2 to the other side according to the balance of the thermal energy. In addition, the SC-CO₂ cycle power plant 2 can supply the thermal energy from the LNG plant 3 while supplying the thermal energy to the LNG plant 3. As described above, the heat exchange can be performed simultaneously and bidirectionally between the LNG plant 3 and the SC-CO₂ cycle power plant 2 in the configuration in which the LNG plant 3 and the SC-CO₂ cycle power plant 2 are provided together, so that a synergy effect can be obtained.

Here, examples of the combined cycle natural gas processing system 1 (FIG. 1) of a type in which the CO₂ gas generated in the LNG plant 3 is directly supplied to the CCS facility 4 and the combined cycle natural gas processing system 1a (FIG. 2) of a type in which the CO₂ gas generated in the LNG plant 3 is supplied to the SC-CO₂ cycle power plant 2 have been described in FIGS. 1 and 2.

Among these, an application example of a technology for performing energy transfer between the SC-CO₂ cycle power plant 2 and the LNG plant 3 with respect to the combined cycle natural gas processing system 1a of the type of FIG. 2 is illustrated in the combined cycle natural gas processing systems 1d to 1f according to the respective embodiments illustrated in FIGS. 5 to 7. However, the respective technologies described with reference to FIGS. 5 to 7 are not limited to the examples illustrated in these drawings, and may be applied to the combined cycle natural gas processing system 1 of the type described with reference to FIG. 1.

As described above, the combined cycle natural gas processing systems 1 and 1a to 1f of the present application include the SC-CO₂ cycle power plant that supplies the high-temperature and high-pressure SC-CO₂ to the power generation turbine 23 or the SC-CO₂ cycle plant that drives the compressor 712 or the like using the high-temperature and high-pressure SC-CO₂ to perform the conversion into mechanical energy (hereinafter, these are also collectively referred to as the “SC-CO₂ plant 2”). In these combined cycle natural gas processing systems 1 and 1a to 1f, the electrical energy, mechanical energy and/or thermal energy generated by using the high-temperature and high-pressure SC-CO₂ are used in the LNG plant 3. Then, CO₂ discharged from the SC-CO₂ plant 2 and the LNG plant 3 is supplied to the CO₂ reception facility. As a result, zero emission is achieved in the entire facility required for the production of LNG.

Specifically, first, the HC gas containing methane as the main component, which is by-produced in the adjacent LNG plant 3, is supplied to the SC-CO₂ plant 2. Then, the high energy of CO₂ obtained by combusting the HC gas under the high temperature and high pressure together with the high-purity O₂ gas (of which the concentration is equal to or higher than 99.8%) obtained by air separation by the ASU 38 is supplied as the electrical energy, mechanical energy, and/or thermal energy. As a result, the thermal energy obtained by the combustion of the HC gas by-produced in the LNG plant 3 is effectively utilized.

Second, the high energy generated in the SC-CO₂ plant is converted into various energy forms as the electrical energy, mechanical energy, or thermal energy, and is used in the LNG plant 3 provided together with the SC-CO₂ plant. This reduces CO₂ generated when the hydrocarbon fuel is independently combusted in the LNG plant 3 in order to obtain required energy.

Third, the CO₂ in the process removed from NG and the CO₂ constantly extracted from the SC-CO₂ plant 2 are isolated in the ground by the CO₂ reception facility and are not released to the atmosphere. Through the above-described integration between facilities, a combined facility that does not discharge the CO₂ in the LNG production process including not only the CO₂ directly generated during the LNG production but also the CO₂ generated as the by-product along with energy supply is constructed.

That is, the combined cycle natural gas processing systems 1 and 1a to 1f of the present examples can produce LNG without depending on renewable energy having unstable power supply capacity or external power that is likely to discharge CO₂ during power generation, and thus, a zero-emission fuel can be achieved. In addition, in a case where carbon dioxide in an exhaust gas discharged from an air-combustion type combustion apparatus is absorbed using a chemical absorbing liquid (so-called Post Combustion), a recovery rate of carbon dioxide remains about 90%. However, the combined cycle natural gas processing systems 1 and 1a to 1f of the present examples can recover the carbon dioxide generated in the present system at a level close to 100%.

In this regard, external fuel receiving type power generation facilities in Patent Literatures 2 and 3 described above do not focus on CO₂ generated in a facility to which energy is supplied and a facility which produces a fuel for power generation. Thus, even if an external fuel receiving type power plant itself includes the CO₂ reception facility, when the facility to which the energy is supplied and the facility which produces the fuel for power generation includes hydrocarbon fuel combustion facilities, CO₂ generated in these combustion facilities is released to the atmosphere. As described above, when the CO₂ reception facility is provided for the external fuel receiving type power generation facility, it is difficult to achieve the zero emission in the entire facility including the facility to which the energy is supplied and the facility which produces the fuel for power generation. As described above, the combined cycle natural gas processing systems 1 and 1a to 1f of the present application do not perform simple and one-sided energy supply as in the conventional external fuel receiving type power generation facilities, but achieves the comprehensive zero emission in combination with the LNG plant 3.

In the combined cycle natural gas processing systems 1 and 1a to 1f according to the respective embodiments described above, the LNG plant 3 is not limited to one having a configuration provided on the ground. For example, the above-described embodiments can also be applied to a floating LNG (FLNG) plant in which the LNG plant 3 is disposed on a floating surface on the water. In this case, all the combined cycle natural gas processing systems 1 and 1a to 1f including the SC-CO₂ cycle power plant 2 may be disposed on the floating surface.

In addition, the SC-CO₂ cycle power plant 2 is not limited to the configuration in which the power generation turbine 23 is driven using SC-CO₂ to generate power. For example, a case of adopting the SC-CO₂ cycle power plant 2 configured to drive the power generation turbine 23 using a CO₂ gas or a liquid CO₂ to generate power is not excluded.

In addition, when excessive power is generated even if the power generated in the SC-CO₂ cycle power plant 2 is supplied to the LNG plant 3 and the power consumption device in the SC-CO₂ cycle power plant 2, the power may be supplied to a region outside the combined cycle natural gas processing systems 1 and 1a to 1f.

In addition, the term “by-produced” is a concept including both a case where the generation amount of the HC gas is not controlled in the process of producing and storing LNG and a case where the generation amount of the HC gas is controlled in consideration of excess or deficiency of fuel although not specifically described in the above embodiments.

### REFERENCE SIGNS LIST

1, 1a, 1b, 1c, 1e, 1f processing system
101 combined cycle natural gas
101 combustor supply gas control unit
102 supply control valve
103a HC gas supply control unit
103b HC gas gas supply control unit
104 extraction control valve
105 LNG temperature control unit
106 flowmeter
2 SC-CO₂ cycle power plant
20 CO₂ cycle
201 liquid CO₂ extraction line
211 HC gas pressurizing unit
212 oxygen gas pressurizing unit
22 combustor
23 power generation turbine
231 generator
232 electrical room
241, 241a, 241b heat exchanger
242 cooler
243 gas-liquid separator
251 compressor
252 cooler
261 drum
262 pressurizing pump
27 CO₂ fluid heating unit
3 LNG plant
30 pretreatment unit
301 HC gas supply line
302 O₂ gas supply line
303 CO₂ gas extraction line
304 CO₂ gas supply line
304a, 304b auxiliary supply line
305 N₂ gas gas supply line
31, 31b AGRU
311 separation unit
312 CO₂ gas pressurizing unit
32 dehydration unit
321 regeneration gas compressor
33 heavy component separation unit
331 NG pressurizing unit
341 liquefying unit
342 liquefaction refrigerant cycle
35 end flash unit
351 LNG pump
352 compressor
36 LNG tank
361 compressor
362 shipping pump
37 acid gas combustion facility
39 nitrogen gas separation unit
391 HC gas supply unit
4 CCS facility
41 CO₂ compressor
42 CO₂ dehydration unit
43 CO₂ compressor
44 cooler
45 gas-liquid separator
46 CO₂ pump
5 LNG carrier
6 aquifer
71 turbine type compressor
711 turbine
712 compressor
72 pump
741 absorption column
742 regeneration column
743 reboiler
81 oxygen combustion heater
82 pump
83 blower

1. A combined cycle natural gas processing system comprising:
a natural gas processing plant that produces liquefied natural gas from natural gas; and
a carbon dioxide cycle power plant that includes a power generation turbine using a carbon dioxide fluid as a driving fluid, and performs power generation using a carbon dioxide cycle that pressurizes and heats the carbon dioxide fluid discharged from the power generation turbine and supplies the carbon dioxide fluid again to the power generation turbine,
wherein the natural gas processing plant includes an acid gas removal unit (AGRU) that separates carbon dioxide contained in the natural gas,
the carbon dioxide cycle power plant includes:
a combustor that is provided on an inlet side of the power generation turbine, mixes the pressurized and heated carbon dioxide fluid with a light hydrocarbon gas containing methane as a main component and a high-purity oxygen gas and combusts the carbon dioxide fluid mixed with the light hydrocarbon gas and the high-purity oxygen gas to generate the carbon dioxide fluid containing high-temperature and high-pressure steam, the light hydrocarbon gas being by-produced when the liquefied natural gas is produced in the natural gas processing plant;
a separator that cools the carbon dioxide fluid containing the steam, discharged from the power generation turbine and decompressed, to condense and separate the steam; and
an extraction facility that extracts a carbon dioxide fluid exceeding a required circulation amount, determined according to electric power that needs to be obtained by the power generation, out of the carbon dioxide fluid from which moisture has been separated by the separator, and
electric power obtained by driving a generator using the power generation turbine is supplied to a power consumption device provided in the natural gas processing plant, the carbon dioxide fluid extracted from the extraction facility and a carbon dioxide separation stream separated by the acid gas removal unit are supplied to a carbon dioxide reception facility capable of receiving carbon dioxide, and the carbon dioxide generated with production of the liquefied natural gas is not released to atmosphere.

2. A combined cycle natural gas processing system comprising:
a natural gas processing plant that produces liquefied natural gas from natural gas; and
a carbon dioxide cycle power plant that includes a power generation turbine using a carbon dioxide fluid as a driving fluid, and performs power generation using a carbon dioxide cycle that pressurizes and heats the carbon dioxide fluid discharged from the power generation turbine and supplies the carbon dioxide fluid again to the power generation turbine,
wherein the natural gas processing plant includes:
an acid gas removal unit (AGRU) that separates carbon dioxide contained in the natural gas;
a pressurizing unit that pressurizes a carbon dioxide separation stream separated by the acid gas removal unit; and
a carbon dioxide supply line that causes the carbon dioxide separation stream pressurized in the pressurizing unit to join the carbon dioxide fluid flowing in the carbon dioxide cycle,
the carbon dioxide cycle power plant includes:
a combustor that is provided on an inlet side of the power generation turbine, mixes the pressurized and heated carbon dioxide fluid with a light hydrocarbon gas containing methane as a main component and a high-purity oxygen gas and combusts the carbon dioxide fluid mixed with the light hydrocarbon gas and the high-purity oxygen gas to generate the carbon dioxide fluid containing high-temperature and high-pressure steam, the light hydrocarbon gas being by-produced when the liquefied natural gas is produced in the natural gas processing plant;
a separator that cools the carbon dioxide fluid containing the steam, discharged from the power generation turbine and decompressed, to condense and separate the steam; and
an extraction facility that extracts a carbon dioxide fluid exceeding a required circulation amount, determined according to electric power that needs to be obtained by the power generation, out of the carbon dioxide fluid from which moisture has been separated by the separator, and
electric power obtained by driving a generator using the power generation turbine is supplied to a power consumption device provided in the natural gas processing plant, the carbon dioxide fluid extracted from the extraction facility is supplied to a carbon dioxide reception facility capable of receiving carbon dioxide, and the carbon dioxide generated with production of the liquefied natural gas is not released to atmosphere.

3. A combined cycle natural gas processing system comprising:
a natural gas processing plant that produces liquefied natural gas from natural gas; and
a carbon dioxide cycle plant that includes an energy conversion turbine configured to convert energy held by a driving fluid into mechanical energy using a carbon dioxide fluid as the driving fluid, and obtains the mechanical energy using a carbon dioxide cycle that pressurizes and heats the carbon dioxide fluid discharged from the energy conversion turbine and supplies the carbon dioxide fluid again to the energy conversion turbine,
wherein the natural gas processing plant includes an acid gas removal unit (AGRU) that separates carbon dioxide contained in the natural gas,
the carbon dioxide cycle plant includes:
a combustor that is provided on an inlet side of the energy conversion turbine, mixes the pressurized and heated carbon dioxide fluid with a light hydrocarbon gas containing methane as a main component and a high-purity oxygen gas and combusts the carbon dioxide fluid mixed with the light hydrocarbon gas and the high-purity oxygen gas to generate the carbon dioxide fluid containing high-temperature and high-pressure steam, the light hydrocarbon gas being by-produced when the liquefied natural gas is produced in the natural gas processing plant;
a separator that cools the carbon dioxide fluid containing the steam, discharged from the energy conversion turbine and decompressed, to condense and separate the steam; and
an extraction facility that extracts a carbon dioxide fluid exceeding a required circulation amount, determined according to the mechanical energy that needs to be obtained by the energy conversion, out of the carbon dioxide fluid from which moisture has been separated by the separator, and
the mechanical energy obtained by driving the energy conversion turbine is supplied to a mechanical energy consumption device provided in the natural gas processing plant, the carbon dioxide fluid extracted from the extraction facility and a carbon dioxide separation stream separated by the acid gas removal unit are supplied to a carbon dioxide reception facility capable of receiving carbon dioxide, and the carbon dioxide generated with production of the liquefied natural gas is not released to atmosphere.

4. A combined cycle natural gas processing system comprising:
a natural gas processing plant that produces liquefied natural gas from natural gas; and
a carbon dioxide cycle plant that includes an energy conversion turbine configured to convert energy held by a driving fluid into mechanical energy using a carbon dioxide fluid as the driving fluid, and recovers energy using a carbon dioxide cycle that pressurizes and heats the carbon dioxide fluid discharged from the energy conversion turbine and supplies the carbon dioxide fluid again to the energy conversion turbine,
wherein the natural gas processing plant includes:
an acid gas removal unit (AGRU) that separates carbon dioxide contained in the natural gas;
a pressurizing unit that pressurizes a carbon dioxide separation stream separated by the acid gas removal unit; and
a carbon dioxide supply line that causes the carbon dioxide separation stream pressurized in the pressurizing unit to join the carbon dioxide fluid flowing in the carbon dioxide cycle,
the carbon dioxide cycle plant includes:
a combustor that is provided on an inlet side of the energy conversion turbine, mixes the pressurized and heated carbon dioxide fluid with a light hydrocarbon gas containing methane as a main component and a high-purity oxygen gas and combusts the carbon dioxide fluid mixed with the light hydrocarbon gas and the high-purity oxygen gas to generate the carbon dioxide fluid containing high-temperature and high-pressure steam, the light hydrocarbon gas being by-produced when the liquefied natural gas is produced in the natural gas processing plant;
a separator that cools the carbon dioxide fluid containing the steam, discharged from the energy conversion turbine and decompressed, to condense and separate the steam; and
an extraction facility that extracts a carbon dioxide fluid exceeding a required circulation amount, determined according to the mechanical energy that needs to be obtained by the energy conversion, out of the carbon dioxide fluid from which moisture has been separated by the separator, and
the mechanical energy obtained by driving the energy conversion turbine is supplied to a mechanical energy consumption device provided in the natural gas processing plant, the carbon dioxide fluid extracted from the extraction facility is supplied to a carbon dioxide reception facility capable of receiving carbon dioxide, and the carbon dioxide generated with production of the liquefied natural gas is not released to atmosphere.

5. The combined cycle natural gas processing system according to claim 3, wherein
the mechanical energy consumption device is a rotary device provided in the natural gas processing plant, and
the energy conversion turbine is a drive turbine configured to drive the rotary device.

6. The combined cycle natural gas processing system according to claim 5, wherein
the carbon dioxide cycle plant further includes a power generation turbine that converts the energy held by the driving fluid into electrical energy, and
electric power obtained by driving a generator using the power generation turbine is supplied to a power consumption device provided in the natural gas processing plant.

7. The combined cycle natural gas processing system according to claim 1, wherein
the carbon dioxide fluid extracted from the extraction facility is supplied to the carbon dioxide reception facility that is at least one selected from a facility group including a carbon dioxide capture and storage (CCS) facility, an enhanced oil recovery (EOR) facility, a urea synthesis facility, a carbon dioxide mineralization facility, a methanation facility, and a carbon dioxide supply facility for photosynthesis promotion.

8. The combined cycle natural gas processing system according to claim 1, wherein
the carbon dioxide separation stream separated by the acid gas removal unit is supplied to a carbon dioxide capture and storage (CCS) facility which is the carbon dioxide reception facility and is configured to pressurize and store the carbon dioxide separation stream, and
the carbon dioxide fluid extracted from the extraction facility is supplied to the CCS facility which is the carbon dioxide reception facility, and joins the pressurized carbon dioxide separation stream, and the joined carbon dioxide fluid and the carbon dioxide separation stream are stored together.

9. The combined cycle natural gas processing system according to claim 1, wherein
the natural gas processing plant includes an air separation unit (ASU) configured to separate air into an oxygen gas and a nitrogen gas to produce the oxygen gas to be supplied to the combustor, and
the air separation unit includes a nitrogen gas supply line configured to supply the obtained nitrogen gas to at least one nitrogen gas use facility selected from a utility facility, a facility that supplies a purge gas to a seal drum of a flare stack, a facility that supplies a blanket gas to a storage tank, and a facility that supplies a microbubble gas for promoting a separation function in an oil-water separation unit.

10. The combined cycle natural gas processing system according to claim 9, wherein
the natural gas processing plant includes a nitrogen gas separation unit that separates a nitrogen gas from the light hydrocarbon gas that is supplied to the combustor and contains the methane as the main component, and
the nitrogen gas separated by the nitrogen gas separation unit joins nitrogen in the nitrogen gas supply line and is used in the nitrogen gas use facility.

11. The combined cycle natural gas processing system according to claim 1, further comprising
an acid gas combustion facility that combusts an acid gas which is separated from the carbon dioxide separation stream and contains a sulfur compound,
wherein the carbon dioxide cycle is provided with a carbon dioxide fluid heating unit that heats the carbon dioxide fluid using combustion exhaust heat of the acid gas in the acid gas combustion facility.

12. The combined cycle natural gas processing system according to claim 1, wherein
the natural gas processing plant includes a light hydrocarbon gas supply line configured to supply a boil-off gas, vaporized in a storage tank storing the liquefied natural gas (LNG), as the light hydrocarbon gas to the combustor.

13. The combined cycle natural gas processing system according to claim 12, wherein
the natural gas processing plant includes:
a main cryogenic heat exchanger that liquefies and subcools the natural gas to obtain the LNG;
an end flash unit that decompresses the LNG sent from the main cryogenic heat exchanger to a pressure of the storage tank and separates an end flash gas generated by the decompressing from the liquefied natural gas;
an auxiliary supply line that causes a light hydrocarbon gas obtained by vaporizing the LNG in the end flash unit to join the light hydrocarbon gas supply line; and
a control unit that executes control to increase a temperature of the LNG at an outlet of the main cryogenic heat exchanger in order to increase an evaporation amount of the LNG in the end flash unit in a case where a supply flow rate of the light hydrocarbon gas supplied from the light hydrocarbon gas supply line to the combustor is less than a target supply flow rate necessary for maintaining the required circulation amount of the carbon dioxide fluid even when an entire amount of the boil-off gas that is suppliable from the storage tank is supplied to the light hydrocarbon gas supply line.

14. The combined cycle natural gas processing system according to claim 12, wherein
the natural gas processing LNG plant includes:
a main cryogenic heat exchanger that liquefies and subcools the natural gas to obtain the LNG;
an auxiliary supply line that extracts a part of the natural gas before being liquefied, which is supplied to the main cryogenic heat exchanger, from an inlet side of the main cryogenic heat exchanger to join the light hydrocarbon gas supply line as the light hydrocarbon gas; and
a control unit that executes control to increase an extraction amount of the natural gas from the inlet side of the main cryogenic heat exchanger in a case where a supply flow rate of the light hydrocarbon gas supplied from the light hydrocarbon gas supply line to the combustor is less than a target supply flow rate necessary for maintaining the required circulation amount of the carbon dioxide fluid even if an entire amount of the boil-off gas that is suppliable from the storage tank is supplied to the light hydrocarbon gas supply line.

15. The combined cycle natural gas processing system according to claim 1, wherein
the power consumption device includes a drive motor of a compressor that executes compression of a refrigerant to compress, cool, and liquefy the refrigerant again after the refrigerant used in the natural gas processing plant for cooling the natural gas is vaporized by heat exchange with the natural gas.

16. The combined cycle natural gas processing system according to claim 1, wherein
the carbon dioxide cycle includes a heat exchange unit that heats a heating medium by heat exchange between the carbon dioxide fluid at a high temperature flowing in the carbon dioxide cycle and the heating medium flowing between the carbon dioxide cycle and the natural gas processing plant, and
the heating medium heated by the heat exchange unit raises a temperature of a fluid to be heated, which flows through a device requiring a heat source provided in the natural gas processing plant, in a heating unit, and then, is supplied again to the heat exchange unit in a state of being lowered in temperature.

17. The combined cycle natural gas processing system according to claim 16, wherein
the acid gas removal unit includes: an absorption column which absorbs an acid gas containing the carbon dioxide contained in the natural gas using a gas absorbing liquid; a regeneration column which regenerates the gas absorbing liquid; and a reboiler which raises a temperature of the gas absorbing liquid in the regeneration column and desorb the absorbed acid gas, and
the heating unit is a reboiler, and the fluid to be heated is the gas absorbing liquid in the regeneration column.

18. The combined cycle natural gas processing system according to claim 4, wherein
the mechanical energy consumption device is a rotary device provided in the natural gas processing plant, and
the energy conversion turbine is a drive turbine configured to drive the rotary device.

19. The combined cycle natural gas processing system according to claim 18, wherein
the carbon dioxide cycle plant further includes a power generation turbine that converts the energy held by the driving fluid into electrical energy, and
electric power obtained by driving a generator using the power generation turbine is supplied to a power consumption device provided in the natural gas processing plant.

20. The combined cycle natural gas processing system according to claim 2, wherein
the carbon dioxide fluid extracted from the extraction facility is supplied to the carbon dioxide reception facility that is at least one selected from a facility group including a carbon dioxide capture and storage (CCS) facility, an enhanced oil recovery (EOR) facility, a urea synthesis facility, a carbon dioxide mineralization facility, a methanation facility, and a carbon dioxide supply facility for photosynthesis promotion.

21. The combined cycle natural gas processing system according to claim 3, wherein
the carbon dioxide fluid extracted from the extraction facility is supplied to the carbon dioxide reception facility that is at least one selected from a facility group including a carbon dioxide capture and storage (CCS) facility, an enhanced oil recovery (EOR) facility, a urea synthesis facility, a carbon dioxide mineralization facility, a methanation facility, and a carbon dioxide supply facility for photosynthesis promotion.

22. The combined cycle natural gas processing system according to claim 4, wherein
the carbon dioxide fluid extracted from the extraction facility is supplied to the carbon dioxide reception facility that is at least one selected from a facility group including a carbon dioxide capture and storage (CCS) facility, an enhanced oil recovery (EOR) facility, a urea synthesis facility, a carbon dioxide mineralization facility, a methanation facility, and a carbon dioxide supply facility for photosynthesis promotion.

23. The combined cycle natural gas processing system according to claim 3, wherein
the carbon dioxide separation stream separated by the acid gas removal unit is supplied to a carbon dioxide capture and storage (CCS) facility which is the carbon dioxide reception facility and is configured to pressurize and store the carbon dioxide separation stream, and
the carbon dioxide fluid extracted from the extraction facility is supplied to the CCS facility which is the carbon dioxide reception facility, and joins the pressurized carbon dioxide separation stream, and the joined carbon dioxide fluid and the carbon dioxide separation stream are stored together.

24. The combined cycle natural gas processing system according to claim 2, wherein
the power consumption device includes a drive motor of a compressor that executes compression of a refrigerant to compress, cool, and liquefy the refrigerant again after the refrigerant used in the natural gas processing plant for cooling the natural gas is vaporized by heat exchange with the natural gas.
